(19) United States
(12) Patent Application Publication
(10) Pub. No.: US 2019/0207649 A1
(43) Pub. Date: Jul. 4, 2019

(54) POWER LINE COMMUNICATION FOR AN AERONAUTICAL SYSTEM

(71) Applicant: THALES USA, INC., Arlington, VA (US)

(72) Inventors: Richard MULLIN, SHAWNEE, KS (US); Tom OTSUBO, OAK GROVE, MO (US)

(21) Appl. No.: 16/233,042

(22) Filed: Dec. 26, 2018

Related U.S. Application Data
(60) Provisional application No. 62/613,314, filed on Jan. 3, 2018.

(51) Int. Cl. H04B 3/54; G05D 1/02; H02J 3/00

(52) U.S. Cl. CPC H04B 3/54; B60L 2240/622; H02J 3/00; G05D 1/0202

(57) ABSTRACT

In an aspect of the disclosure, a method, apparatus, and a computer-readable medium enable communication among one or more ground stations. In certain configurations, the method, apparatus, and computer-readable medium may provide power line communication among a plurality of ground-based aeronautical equipment installations. In certain aspects, the plurality of ground-based aeronautical equipment installations may include a first station and a second station. In certain other configurations, the method, apparatus, and computer-readable medium may send, using the power line communication, a signal from the first station to the second station.

### RELATED APPLICATION

The present application claims the benefit of and priority to U.S. Provisional Patent Application No. 62/613,314, filed Jan. 3, 2018, entitled “POWER LINE COMMUNICATION FOR AN AERONAUTICAL SYSTEM,” the disclosure of which is hereby incorporated herein by reference in its entirety.

### FIELD

The disclosure relates generally to the field of navigation aid equipment, and more specifically to methods, apparatuses, and computer-readable media for communication among devices in an aeronautical system.

### BACKGROUND

Aeronautical systems provide relevant types of information to aircraft and ground-based aeronautical stations that may allow for safe and accurate aircraft positioning. One type of aeronautical system is a navigational aid system. Navigational aid systems may include ground stations used to monitor and control the ground stations. Ground stations may include Distance Measuring Equipment (DME), TACtical Air Navigation (TACAN), Very high frequency Omni-directional Range (VOR), Instrument Landing System (ILS), Marker Beacons (MB), and Non-Directional Beacons (NDB).

There exists a need to support communication between devices in an aeronautical system to ensure maximum accuracy of aircraft positioning.

### SUMMARY

In an aspect of the disclosure, a method, apparatus, and a computer-readable medium enable communication between one or more ground stations. In certain configurations, the method, apparatus, and computer-readable medium may provide power line communication among the plurality of ground-based aeronautical equipment installations. In certain aspects, the plurality of ground-based aeronautical equipment installations may include a first station and a second station. In certain other configurations, the method, apparatus, and computer-readable medium may send, using the power line communication, a signal from the first station to the second station.

In certain other configurations, the method, apparatus, and computer-readable medium may provide power line communication among the plurality of ground-based aeronautical equipment installations. In certain aspects, the plurality of ground-based aeronautical equipment installations may include a first station and a second station. In certain other configurations, the method, apparatus, and computer-readable medium may receive, using the power line communication, a signal at the first station from the second station. In certain other configurations, the method, apparatus, and computer-readable medium may communicate information associated with the signal.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

FIG. 1 is a diagram illustrating an example aspect of an aeronautical system in accordance with aspects of the present disclosure.

FIG. 2 is a flowchart of a method of communication for a ground station in accordance with aspects of the present disclosure.

FIG. 3 is a system diagram illustrating various example hardware components and other features, for use in accordance with aspects of the present disclosure.

FIG. 4 is a flowchart of a method of communication for a ground station in accordance with aspects of the present disclosure.

FIG. 5 is a system diagram illustrating various example hardware components and other features, for use in accordance with aspects of the present disclosure.

FIG. 6 is a diagram illustrating an example aspect of a general-purpose computer system on which various features of the systems and methods for providing mobile ad hoc networking capability to a radio system may be implemented according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a remote device will now be presented with reference to various methods, apparatuses, and media. These methods, apparatuses, and media will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall implementation.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium or media. Computer-readable media includes computer storage media. Storage media may be any available media that is able to be accessed by a computer. By way of example, and not limitation, such computer-readable media may comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that may be used to carry or store desired program code in the form of instructions or data structures and that may be accessed by a computer. Disk and disc, as used herein, include CD, laser disc, optical disc, digital versatile disc (DVD), and floppy disk, where disks usually reproduce data magnetically, while discs reproduce data optically with lasers. Combinations of the above should also be included within the scope of computer-readable media.

Aspects of the method, apparatus, and medium presented herein may be compatible with either one or more ground stations. For example, the method, apparatus, and medium may be compatible with the following: DME, TACAN, VOR, ILS, MB, NDB, RCSU, airfield equipment, maintenance monitoring equipment, intercom devices at an airfield site, maintenance monitoring status reporting devices, automatic terminal information service (ATIS) equipment, runway visual range (RVR) equipment, airport weather monitoring equipment, and/or a cellular base station, just to name a few.

Aeronautical systems provide relevant types of information to aircraft and ground stations that may allow for safe and accurate aircraft positioning. One type of ground station that may be a part of an aeronautical system is a navigational aid station. Navigational aid stations may include ground stations used to monitor and control the ground stations. Ground stations may include DME, TACAN, VOR, ILS, MB, and NDB.

Another type of ground station that may be part of an aeronautical system is an intercom device that enables communication between different airfield sites. ATIS equipment may also be part of an aeronautical system.

RVR equipment may be part of an aeronautical system, and may be used to determine the distance down the runway that may be visible to a pilot in an approaching aircraft, for example. RVR equipment may include sensors that collect visibility information that is communicated to a remote device (e.g., located in an air traffic control tower). The remote device may communicate the visibility information to approaching aircraft, and output the information to air traffic controllers, for example.

Airport weather monitoring equipment may also be part of an aeronautical system, and may include sensors that are designed to gather meteorological observations to support safe and efficient aviation operations, including weather forecasting and climatology information. The sensors may communicate the meteorological information to a remote device that may output the meteorological information to air traffic controllers and/or communicate the meteorological information to aircraft.

To assure maximum safety, the status of each ground station (e.g., ground-based navigational aid stations) in an aeronautical system may be continuously monitored by a remote device such as, e.g., a RCSU. For example, each of the ground stations may have a safety and/or integrity monitor incorporated therewith, and information obtained by safety and/or integrity monitor may be communicated to the RCSU. The remote device may output information related to the accuracy and/or functionality of operation of the ground stations in order to ensure maximum safety of the aeronautical system.

Communication between ground station(s) in an aeronautical system may be accomplished using buried communication cables specifically installed to enable communication between the ground stations. However, due to the distances between various ground stations in an aeronautical system (e.g., a monitoring device located in an air traffic control tower and ground stations located proximate to the runway), the cost associated with installing buried communication cables may be undesirably high. Alternatively, using wireless communication to enable communication between ground station(s) in an aeronautical system may be undesirable due to the potential for dropped data packets that may reduce the accuracy of performance, and/or the risk of wireless intruders gaining unauthorized access to the navigation aid system, for example.

There exists a need to enable communication between one or more ground station(s) in an aeronautical system that may be accomplished without buried communication cables specifically installed for controlling and/or monitoring ground station(s), that has a minimal chance of experiencing data packet loss, and that reduces the risk of unauthorized access by wireless intruders.

Aspects of the present disclosure provide a solution to the problem by enabling communication using power lines that are connected (e.g., serially connected) to ground station(s) in an aeronautical system. Power line communication uses existing electrical wiring, whether in a building or in the utility grid, as network cables, meaning the power lines may also be used carry data signals. Power line communication may thereby extend an existing network into new places without adding new wires. A power line may be transformed into a data line via the superposition of a low-energy information signal to the power wave. Data may be transmitted at a frequency several magnitudes higher than that of the electrical current to ensure that the data signal does not interfere with the power wave, and vice versa. For example, a power line may carry electrical current at a frequency of, e.g., 50 to 60 Hz, and data at a frequency of, e.g., 3 kHz. In some embodiments, the information signal superimposed on a power wave may have a frequency of mHz or gHz.

By enabling communication using power lines, installation and material costs may be reduced (as compared to using buried communication cables), the chance of data packet loss may be reduced, and security may be increased (as compared with wireless communication) by reducing the risk of unauthorized access of wireless intruders. The various end stations can communicate through their respective power lines, which provide power to power their operational circuits, by superimposing (e.g., adding) low energy information waveforms onto the power waveforms provided through their respective power lines. The superimposed low energy information waveforms are thereby transported through the power lines for receipt by each of the end stations which are connected to be powered by the power lines. The low energy information waveforms can be generated by modulating a carrier waveform, which has a substantially higher frequency than the power waveforms, by an information data transport pattern which is to be transported through the power lines to the other end stations. An end station can receive the information data transport pattern through a reverse process of filtering the signal received through the power line to remove the power waveform component, and then demodulating the information data transport pattern from the remaining carrier waveform component.

In some embodiments, each of the end stations may utilize a different carrier frequency to avoid or prevent occurrence of collisions during simultaneous communications by two or more of the end stations. Each of the end stations can have a unique station identifier which may be used by the respective end station to select a carrier frequency, e.g., from among a defined group of available carrier frequencies, which is to be used for communication by the end station through its power line.

There is a risk that unsecured (e.g., unencrypted) information which is transported through the power lines could be monitored by an unauthorized device that is connected to one of the power lines. Moreover, a malicious or other unauthorized device connected to one of the power lines may transmit data through the power line which may interfere with communications by authorized end stations or may be misunderstood by one or more end stations as having originated from a known end station (i.e., if the unauthorized device spoofs the identity of the known end station). In some embodiments, the end stations may receive or generate encryption keys that are used to encrypt information data transport patterns that are communicated through the power lines, and to decrypt information data transport patterns that are received through the power lines. The encryption keys may be generated based on key data exchanged between the end stations through the power lines. Alternatively, the encryption keys may be generated based on key data exchanged between the end stations through a wireless communication channel outside the power lines, e.g., cellular data communications, WiFi, data communications, etc, and/or may be programmed into local memory during manufacturing or subsequent setup of the end station.

In some embodiments, each of the end stations has a unique station identifier which may be used during the operations for generating encryption keys for the end stations. In this manner, an unauthorized device cannot spoof the identity of one of the valid end stations without the authorized end stations identifying the invalid encryption key. The authorized end stations would not be able to properly decrypt the encrypted information received from an unauthorized device, since the unauthorized device would not have encrypted the information with a valid key. Alternatively or additionally, the unique station identifier may be embedded in a header or at another defined location(s) in communication packet(s) transporting the information.

In some embodiments, the end stations determine their relative sequential order along a power line cable relative to the power source. The end stations may operate to measure timing of when they receive a timing signal transmitted from the power source, communicate between the end stations to compare their respective receipt timings, and determine their relative sequential order along the power line cable based on the comparison (i.e., the closest end station to the power source will have the shortest receipt timing and the furthest end station to the power source will have the longest receipt timing).

The encryption keys used by the end stations may be generated based on their relative sequential order along the power line cable relative to the power source. Thus, for example, a first, second, third, through Nth ordered one of the end stations may combine an indication of their respective order with one or more other values for use in an algorithm which generates their respective encryption keys. By further example, a first ordered one of the end station uses an encryption key for communication that is generated based on it being the first ordered one, a second ordered one of the end station uses an encryption key for communication that is generated based on it being the second ordered one, and an Nth ordered one of the end station uses an encryption key for communication that is generated based on it being the Nth ordered one. Because the end stations are usually statically mounted (e.g., secured to concrete structures) at defined locations relative to airport runways or other structure or geographically defined location and are connected to power lines buried under ground, the order of the respective end stations along a trunk of power lines relative to a power source is static. The order of connection can be used to further uniquely identify each of the end stations for purposes of secure communication. This further security for communications can further complicate or render ineffective attempts by a malicious or authorized operator to listen-in on power line communications or spoof the identity of an authorized end station.

The encryption keys used by one of the end stations may be generated based on a measure of distance between the end station and another designated end station, a management (e.g., master) communication node, an operator console node, and/or a power source. Thus, for example, each of the end stations may determine their respective distances from the another designated end station, a management (e.g., master) communication node, an operator console node, and/or a power source, and combine an indication of their respective distance with one or more other values for use in an algorithm which generates their respective encryption keys. The distance may be determined based on timing offset between when a timing signal is received by an end station and when the timing signal was transmitted relative to a global clock reference signal. Alternatively or additionally, the distance may be determined based on measuring a time-of-flight for a reference signal to travel between the end station and the designated end station, the management (e.g., master) communication node, the operator console node, and/or the power source. Because the end stations are usually statically mounted (e.g., secured to concrete structures) at defined locations the respective distance along power lines is also static relative to the designated end station, the management (e.g., master) communication node, the operator console node, and/or the power source. The determined distances can therefore also uniquely identify each of the end stations for purposes of secure communication. This further security for communications can further complicate or render ineffective attempts by a malicious or authorized operator to listen-in on power line communications or spoof the identity of an authorized end station.

A plurality of end stations may be connected to a same trunk of a power line cable. There is a risk that a cut or other failure of the power line cable will result in loss of power being delivered to and return communications being received from one or more end stations that are more remotely located after the point of failure along the power line cable from a power source to the power line cable. In some embodiments, the end stations are configured to determine when one or more end stations that are further away in a determined sequence order along the power line cable relative to a power source has/have become unresponsive, and to report the unresponsive status to one or more other of the end stations and/or to a central operations monitoring node.

In some embodiments, the end stations are configured to reduce the occurrence of or potential for communication collisions on a power line cable, e.g., trunk, by scheduling timing of their communications through their power lines based on their determined sequence order along the power line cable relative to the power source. For example, each of the end stations may be scheduled to use different non-overlapping division multiplexing slots, which are assigned to different ones of the end stations based on their sequence order along the power line cable. In this manner, the assignment of communication slots to particular end stations can be performed in a distributed manner by the collective operation of the end stations without necessitating use of a master device that controls when particular end stations are to be scheduled for communications.

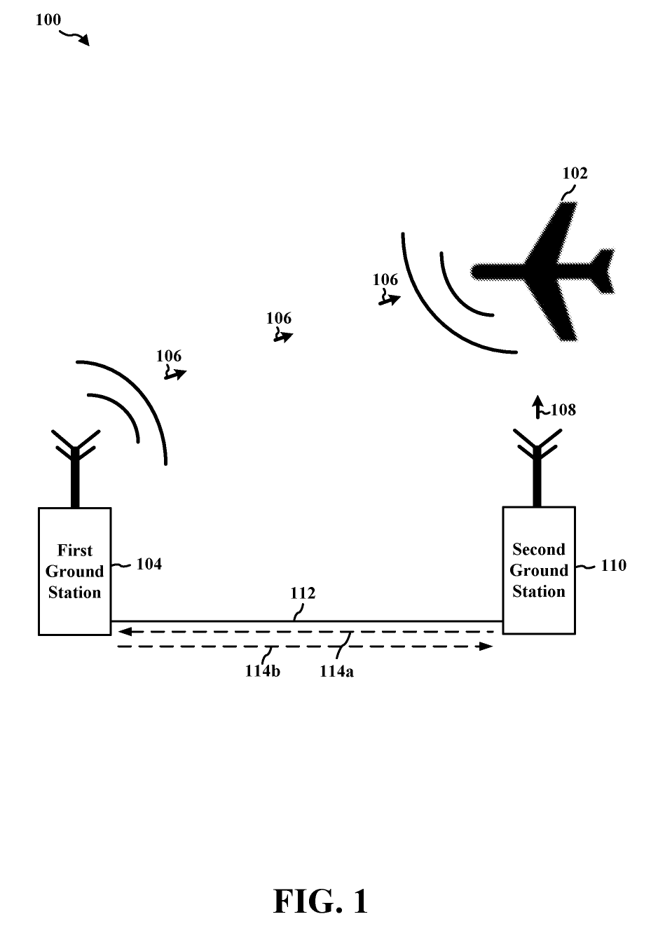

FIG. 1 illustrates an overall system diagram of an example aeronautical system 100 for use in accordance with aspects of the present disclosure. The example aeronautical system of FIG. 1 includes, for example, an aircraft 102, a first ground station 104, a second ground station 110, and a power line 112 that is serially connected to the first ground station 104 and the second ground station 110. The first ground station 104 may correspond to, e.g., one or more of a DME ground system, a localizer, a glide slope, a TACAN system, a VOR system, an ILS, MB, NDB, on-airfield equipment, an airfield site intercom device, an airfield site maintenance monitoring device, ATIS equipment, runway visual range equipment, or airport weather monitoring equipment, just to name a few. The second ground station 110 may correspond to, e.g., one or more of an RCSU (e.g., located in an air traffic control tower), DME ground system, a localizer, a glide slope, a TACAN system, a VOR system, an ILS, MB, NDB, on-airfield equipment, an airfield site intercom device, an airfield site maintenance monitoring device, ATIS equipment, runway visual range equipment, airport weather monitoring equipment, a cellular base station, just to name a few.

The power line 112 may be configured to provide power to one or more of the first ground station 104 and/or the second ground station 110 to power their respective operational circuits. In certain configurations, the power line 112 may be subterranean. In certain other configurations, the power line 112 may be located above ground.

VOR/DME, VOR/TACAN, ILS/DME, and/or ILS/TACAN facilities may be identified by the aircraft 102 with synchronized identification signals that are transmitted on a time share basis. For example, the DME or TACAN coded identification signal 108 may be transmitted once for each three coded identification signals 106 that is transmitted by the VOR or ILS (e.g., localizer).

In a first configuration, when the first ground station 104 includes a localizer that transmits a coded identification signal 106 at three equally spaced intervals to the aircraft 102, a signal 114a may be sent via the power line 112 in order to trigger the transmission of a coded identification signal 108 that is equally spaced from the last of the three transmissions of the coded identification signal 106. In certain aspects, the second ground station 110 (e.g., a DME) may send a signal 114b via the power line 112 to the first ground station 104 indicating that the coded identification signal 108 was sent. The signal 114b is sent by the second ground station 110 superimposing information that is to be transported by signal 114b as low-energy information superimposed onto power waveforms that are provided through the power line to power the operation of the first ground station 104.

In a second configuration, the first ground station 104 may include an aeronautical station (e.g., DME, a localizer, a glide slope, a TACAN system, a VOR system, an ILS, an MB, an NDB, a maintenance monitoring device,), and the second ground station 110 may include a monitoring device (e.g., an RCSU, a far field monitor for a localizer). The signal 114a sent via the power line 112 may include information indicating a status of the first ground station 104. For example, the status information may indicate if the first ground station 104 is functional or non-functional. The status information may be output as a visual and/or audio display (e.g., ‘Functional,’ ‘Non-Functional’) at the second ground station 110.

In a third configuration, the first ground station 104 may include a first intercom device at a first airfield site (e.g., a first location at an airport), and the second ground station 110 may include a second intercom device at a second airfield site (e.g., a second location at the airport). The first intercom device and the second intercom device may send respective signals 114a, 114b (e.g., audio signals, broadcast signals, voice signals) via the power line 112 that may be output at the receiving intercom device.

In a fourth configuration, the first ground station 104 may include a VOR, and the second ground station 110 may include an ATIS device. The VOR and the second ATIS device may send respective signals 114a, 114b (e.g., ATIS broadcast information) to one another, for example, when either device receives an update to the ATIS broadcast information. Examples of ATIS broadcast information include recorded aeronautical information, such as current weather information, active runways, available approaches, and any other information used by the aircraft 102 for landing. Pilots may listen to an available ATIS broadcast, for example, before contacting the local control unit (e.g., air traffic control tower), which may reduce the controllers' workload and relieves frequency congestion.

In a fifth configuration, the first ground station 104 may include a first RVR device (e.g., RVR sensor(s)), and the second ground station 110 may include a second RVR device (e.g., a remote device that determines runway visibility located in the air traffic control tower). A signal 114a may be sent via the power line 112 from the first RVR device to the second RVR device, and the second RVR device may determine runway visibility based at least in part on the received signal 114a. The determined runway visibility may be used to update the ATIS broadcast.

In a sixth configuration, the first ground station 104 may include a first airport weather monitoring device (e.g., thermometer, pressure sensor, moisture sensor, wind sensor), and the second ground station 110 may include a second airport weather monitoring device (e.g., a remote device that determines weather conditions). A signal 114a may be sent via the power line 112 from the first weather monitoring device to the second weather monitoring device, and the second weather monitoring device may determine weather conditions (e.g., temperature, wind speed, wind direction, change of rain) based at least in part on the received signal 114a. The second weather monitoring device may communicate the determined weather conditions to the aircraft 102.

In a seventh configuration, the first ground station 104 may be a VOR, and the second ground station 110 may be a cellular base station. A signal 114a may be sent via the power line 112 from the VOR to the cellular base station, and the cellular base station may wirelessly communicate the signal to a maintenance monitoring center.

By using the power lines 112 for communication among ground stations in the aeronautical system 100, installation and material costs may be reduced (as compared to using buried communication cables), the chance of data packet loss may be reduced, and security may be increased (as compared with wireless communication) by reducing the risk of unauthorized access of wireless intruders. In addition, the use of buried lines may enhance communication reliability (e.g., use of existing buried power lines to form a communication network may reduce the risk of interfering damage to the communication lines).

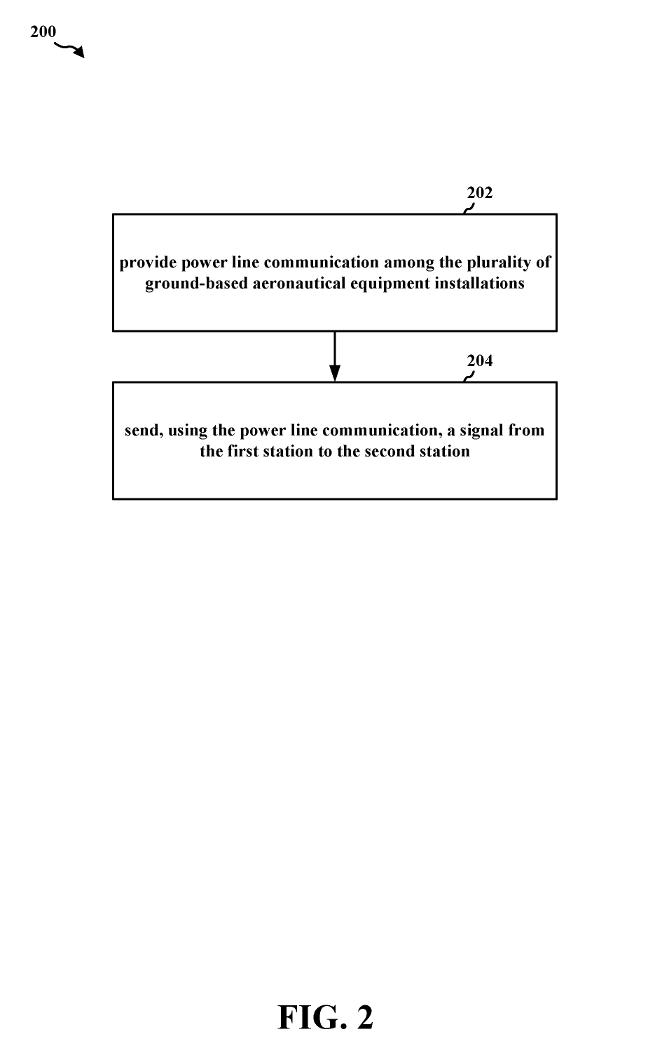

FIG. 2 contains a flowchart 200 of a method of communication in accordance with certain example features in accordance with aspects of the disclosure. For example, the method may be performed by the first ground station 104 illustrated in FIG. 1. In an aspect, the method described infra with respect to FIG. 2 may be used to enable communication among ground stations in an aeronautical system.

In 202, the first station is able to provide power line communication among the plurality of ground-based aeronautical equipment installations that includes a second station. For example, referring to FIG. 1, the first ground station 104 may use existing electrical wiring (e.g., power lines 112), whether in a building or in the utility grid, as network cables, to carry data signals. Power line communication may extend an existing network into new places without adding new wires. A power line 112 may be transformed into a data line via the superposition of a low-energy information signal to the power wave. Data may be transmitted at a frequency several magnitudes higher than that of the electrical current to ensure that the power wave does not interfere with the data signal. For example, a power line 112 may carry electrical current at a frequency of, e.g., 50 to 60 Hz, and the power line 112 may carry data from the first ground station 104 to the second ground station 110 at about 3 kHz.

In 204, the first station is able to send, using the power line communication, a signal from the first station to the second station. In a first example, referring to FIG. 1, when the first ground station 104 includes either a VOR or localizer that transmits a coded identification signal 106 at three equally spaced intervals to the aircraft 102, a signal 114a may be sent via the power line 112 in order to trigger the transmission of a coded identification signal 108 that is equally spaced from the last of the three transmissions of the coded identification signal 106. In certain aspects, the second ground station 110 may send a signal 114b via the power line 112 to the first ground station 104 indicating that the coded identification signal 108 was sent. In a second example, referring to FIG. 1, the first ground station 104 may include an aeronautical station (e.g., DME, a localizer, a glide slope, a TACAN system, a VOR system, an ILS, an MB, an NDB, a maintenance monitoring device), and the second ground station 110 may include a monitoring device (e.g., an RCSU). The signal 114a sent via the power line 112 may include information indicating a status of the first ground station 104. For example, the status information may indicate if the first ground station 104 is functional or non-functional. In a third example, referring to FIG. 1, the first ground station 104 may include a first intercom device at a first airfield site (e.g., a first location at an airport), and the second ground station 110 may include a second intercom device at a second airfield site (e.g., a second location at the airport). The first intercom device and the second intercom device may send respective signals 114a, 114b (e.g., audio signals, broadcast signals, voice signals) via the power line 112 that may be output at the receiving intercom device. In a fourth example, referring to FIG. 1, the first ground station 104 may include a first ATIS device, and the second ground station 110 may include a second ATIS device. The first ATIS device and the second ATIS device may send respective signals 114a, 114b (e.g., ATIS broadcast information) to one another when either device receives an update to the ATIS broadcast information. Examples of ATIS broadcast information include recorded aeronautical information, such as current weather information, active runways, available approaches, and any other suitable information that may be used by the aircraft 102 for landing. Pilots may listen to an available ATIS broadcast before contacting the local control unit (e.g., air traffic control tower), which may reduce the controllers' workload and relieve frequency congestion. In a fifth example, referring to FIG. 1, the first ground station 104 may include a first RVR device (e.g., RVR sensor(s)), and the second ground station 110 may include a second RVR device (e.g., a remote device that determines runway visibility). A signal 114a may be sent via the power line 112 from the first RVR device to the second RVR device, and the second RVR device may determine runway visibility based at least in part on the received signal 114a. The second RVR device may communicate the determined runway visibility to the aircraft 102. In a sixth example, referring to FIG. 1, the first ground station 104 may include a first airport weather monitoring device (e.g., thermometer, pressure sensor, moisture sensor, wind sensor), and the second ground station 110 may include a second airport weather monitoring device (e.g., a remote device that determines weather conditions). A signal 114a may be sent via the power line 112 from the first weather monitoring device to the second weather monitoring device, and the second weather monitoring device may determine weather conditions (e.g., temperature, wind speed, wind direction, change of rain) based at least in part on the received signal 114a. The second weather monitoring device may communicate the determined weather conditions to the aircraft 102. In a seventh example, referring to FIG. 1, the first ground station 104 may be a VOR, and the second ground station 110 may be a cellular base station. A signal 114a may be sent via the power line 112 from the VOR to the cellular base station, and the cellular base station may wirelessly communicate the signal to a maintenance monitoring center.

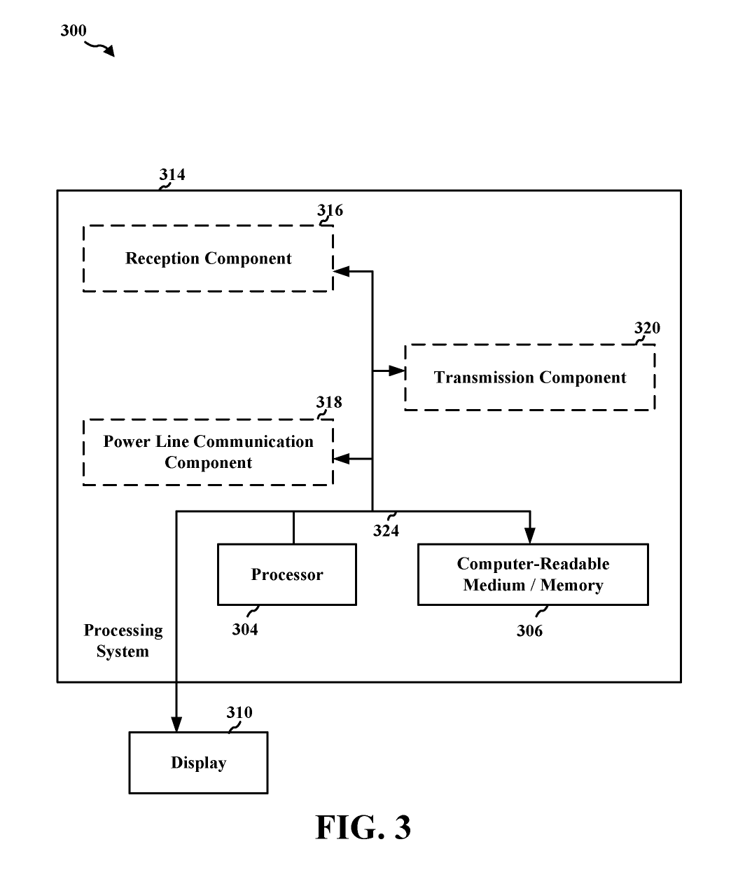

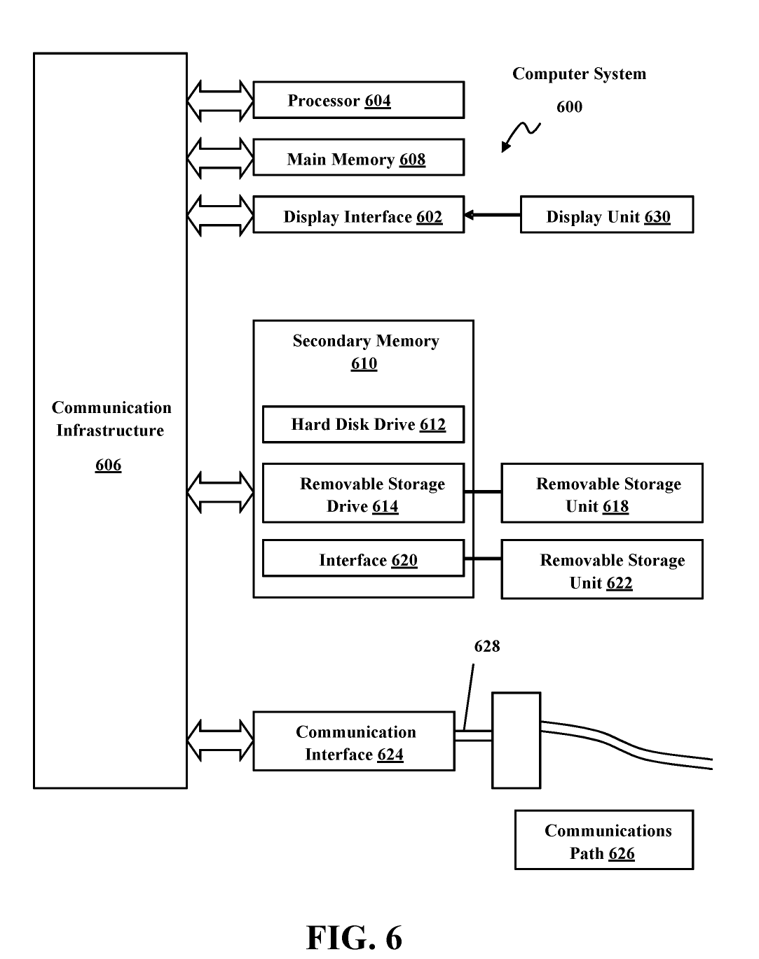

FIG. 3 is a diagram illustrating an example hardware implementation for a system 300 employing a processing system 314. The processing system 314 may be implemented with an architecture that links together various circuits, including, for example, one or more processors and/or components, represented by the processor 304 (see e.g., various features of an example processor of FIG. 6 usable in accordance with aspects of the present disclosure), the components 316, 318, 320 and the computer-readable medium/memory 306.

The processing system 314 may be coupled to a first ground station 104, e.g., such as an RCSU, an airfield site intercom device, maintenance monitoring equipment, an airfield site maintenance monitoring device, a DME ground system, ATIS equipment, runway visual range equipment, and/or airport monitoring equipment, just to name a few. The processing system 314 may use power line communication to communicate with a second ground station 110, e.g., such as one or more of an RCSU, DME ground system, a localizer, a glide slope, a TACAN system, a VOR system, an ILS, MB, NDB, on-airfield equipment, an airfield site intercom device, an airfield site maintenance monitoring device, ATIS equipment, runway visual range equipment, airport weather monitoring equipment, or a cellular base station just to name a few.

The processing system 314 may include a processor 304 coupled to a computer-readable medium/memory 306 and a display 310 via bus 326. The processor 304 may be responsible for general processing, including the execution of software stored on the computer-readable medium/memory 306. The software, when executed by the processor 304, may cause the processing system 314 to perform various functions described supra for any particular apparatus and/or system. The computer-readable medium/memory 306 may also be used for storing data that is manipulated by the processor 304 when executing software. The processing system 314 may further include at least one of the components 316, 318, 320. The components may comprise software components running in the processor 304, resident/stored in the computer readable medium/memory 306, one or more hardware components coupled to the processor 304, or some combination thereof. The processing system 314 may comprise a component of a first ground station 104, e.g., as described above in connection with FIG. 1

The system 300 may further include features for providing power line communication among the plurality of ground-based aeronautical equipment installations, the plurality of ground-based aeronautical equipment installations including a first station and a second station; wherein the first station includes a localizer, the second station includes a DME station, and the signal includes an identification synchronization signal; wherein the first station includes a ground-based navigational aid station, the second station includes a monitoring device, and the signal includes information associated with a status of the ground-based navigational aid station; wherein the ground-based navigational aid station includes at least one of a DME ground system, a localizer, a glide slope, a TACAN system, a VOR system, an ILS, an MB, an NDB, or a maintenance monitoring device; wherein the monitoring device includes a RCSU or a maintenance monitoring unit; wherein the first station includes a first intercom device at a first airfield site, the second station includes a second intercom device at a second airfield site, and the signal includes information to be output at the second intercom device; wherein the first station includes a first ATIS device, the second station includes a second ATIS device, and the signal includes information associated with aeronautical information to be output at the second ATIS device; wherein the first station includes a first RVR device, the second station includes a second RVR device, and the signal includes information associated with RVR; wherein the first station includes a first airport weather monitoring device, the second station includes a second airport weather monitoring device, and the signal includes information associated with meteorology; and sending, using the power line communication, a signal from the first station to the second station.

The aforementioned features may be carried out via one or more of the aforementioned components of the system 300 and/or the processing system 314 of the system 300 configured to perform the functions recited by the aforementioned features.

Thus, aspects may include a system for enabling and ensuring communication among a remote device and one or more ground devices using power line communication, e.g., in connection with FIG. 3.

The system may include additional components that perform each of the functions of the method of the aforementioned flowchart of FIG. 2, or other algorithm. As such, each block in the aforementioned flowchart of FIG. 2 may be performed by a component, and the system may include one or more of those components. The components may include one or more hardware components specifically configured to carry out the stated processes/algorithm, implemented by a processor configured to perform the stated processes/algorithm, stored within a computer-readable medium for implementation by a processor, or some combination thereof.

Thus, aspects may include a non-transitory computer-readable medium for performing a hazard analysis of navigation aid equipment using a safety monitor, the non-transitory computer-readable medium having control logic stored therein for causing a computer to perform the aspects described in connection with, e.g., FIG. 2.

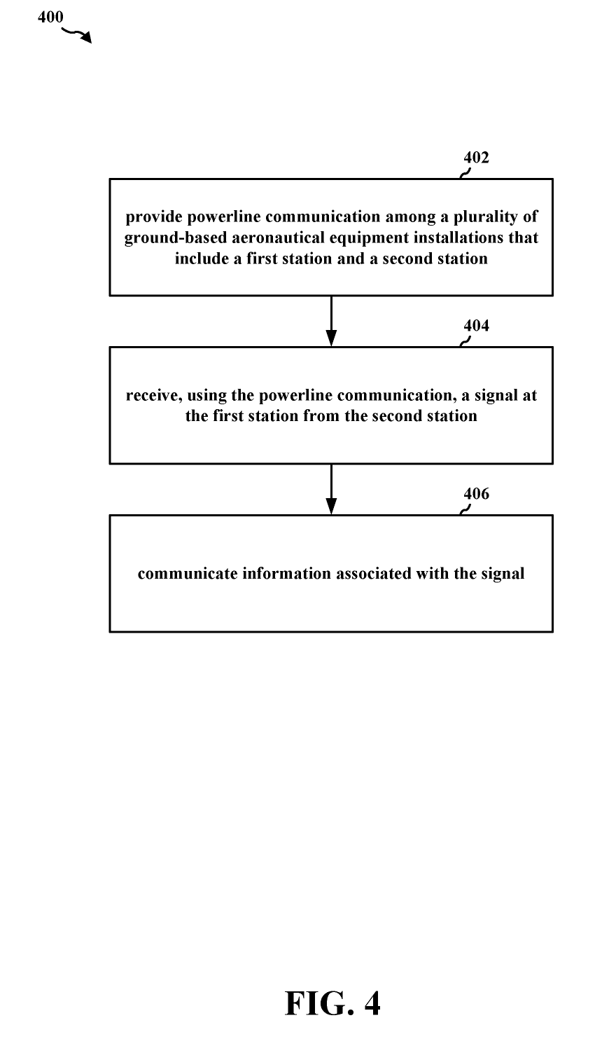

FIG. 4 is flowchart 400 of a method of verifying reliable communication in accordance with certain aspects of the disclosure. For example, the method may be performed by the second ground station 110 illustrated in FIG. 1. In an aspect, the method described infra with respect to FIG. 4 may be used to enable communication among ground stations in an aeronautical system.

In 402, the first ground station (e.g., second ground station 110 in FIG. 1) may be able to provide power line communication among a plurality of ground-based aeronautical equipment installations that include a second station (e.g., first ground station 104 in FIG. 1). For example, referring to FIG. 1, the second ground station 110 may use existing electrical wiring (e.g., power lines 112), whether in a building or in the utility grid, as network cables, to carry data signals. Power line communication may extend an existing network into new places without adding new wires. A power line 112 may be transformed into a data line via the superposition of a low-energy information signal to the power wave. Data may be transmitted at a frequency several magnitudes higher than electrical current frequency to ensure that the power wave does not interfere with the data signal. For example, a power line 112 may carry an electrical current at a frequency of, e.g., 50 to 60 Hz, and the power line 112 may carry data from the first ground station 104 to the second ground station 110 at 3 kHz.

In 404, the first ground station is able to receive, using the power line communication, a signal transmitted from the second station. In a first example, referring to FIG. 1, when the first ground station 104 includes either a VOR or localizer that transmits a coded identification signal 106 at three equally spaced intervals to the aircraft 102, for example, a signal 114a may be sent via the power line 112 in order to trigger the transmission of a coded identification signal 108 at the second ground station 110 that is equally spaced from the last of the three transmissions of the coded identification signal 106. In certain aspects, the second ground station 110 may send a signal 114b via the power line 112 to the first ground station 104 indicating that the coded identification signal 108 was sent. In a second example, referring to FIG. 1, the first ground station 104 may include an aeronautical station (e.g., DME, a localizer, a glide slope, a TACAN system, a VOR system, an ILS, an MB, an NDB, a maintenance monitoring device), and the second ground station 110 may include a monitoring device (e.g., an RCSU). The signal 114a sent via the power line 112 may include information indicating a status of the first ground station 104.

For example, the status information may indicate if the first ground station 104 is functional or non-functional. In a third example, referring to FIG. 1, the first ground station 104 may include a first intercom device at a first airfield site (e.g., a first location at an airport), and the second ground station 110 may include a second intercom device at a second airfield site (e.g., a second location at the airport). The first intercom device and the second intercom device may send respective signals 114a, 114b (e.g., audio signals, broadcast signals, voice signals) via the power line 112 that may be output at the receiving intercom device. In a fourth example, referring to FIG. 1, the first ground station 104 may include a first ATIS device, and the second ground station 110 may include a second ATIS device. The first ATIS device and the second ATIS device may send respective signals 114a, 114b (e.g., ATIS broadcast information) to one another when either device receives an update to the ATIS broadcast information. Examples of ATIS broadcast information include recorded aeronautical information, such as current weather information, active runways, available approaches, and any other suitable information that may be used by the aircraft 102 for landing. Pilots may listen to an available ATIS broadcast before contacting the local control unit (e.g., air traffic control tower), which may reduce the controllers' workload and relieve frequency congestion. In a fifth example, referring to FIG. 1, the first ground station 104 may include a first RVR device (e.g., RVR sensor(s)), and the second ground station 110 may include a second RVR device (e.g., a remote device that determines runway visibility). A signal 114a may be sent via the power line 112 from the first RVR device to the second RVR device, and the second RVR device may determine runway visibility based at least in part on the received signal 114a. The second RVR device may communicate the determined runway visibility to the aircraft 102.

In a sixth example, referring to FIG. 1, the first ground station 104 may include a first airport weather monitoring device (e.g., thermometer, pressure sensor, moisture sensor, wind sensor), and the second ground station 110 may include a second airport weather monitoring device (e.g., a remote device that determines weather conditions). A signal 114a may be sent via the power line 112 from the first weather monitoring device to the second weather monitoring device, and the second weather monitoring device may determine weather conditions (e.g., temperature, wind speed, wind direction, change of rain) based at least in part on the received signal 114a. The second weather monitoring device may communicate the determined weather conditions to the aircraft 102.

In 406, the first ground station may be able to communicate information associated with the signal. In a first example, referring to FIG. 1, when the first ground station 104 includes either a VOR or localizer that transmits a coded identification signal 106 at three equally spaced intervals to the aircraft 102, a signal 114a may be sent via the power line 112 in order to trigger the transmission of a coded identification signal 108 (e.g., communicated information associated with the signal) at the second ground station 110 that is equally spaced from the last of the three transmissions of the coded identification signal 106. In a second example, referring to FIG. 1, status information (e.g., information associated with the signal) may be output as a visual and/or audio display (e.g., ‘Functional,’ ‘Non-Functional’) at the second ground station 110. In a third example, referring to FIG. 1, the first intercom device and the second intercom device may send respective signals 114a, 114b (e.g., audio signals, broadcast signals, voice signals) via the power line 112 that may be output at the receiving intercom device. In a fourth example, referring to FIG. 1, ATIS broadcast information include recorded aeronautical information, such as current weather information, active runways, available approaches, and any other information that is transmitted by the first ATIS device and/or the second ATIS device to the aircraft 102. In a fifth example, referring to FIG. 1, the second RVR device may communicate the determined runway visibility to the aircraft 102. In a sixth example, referring to FIG. 1, he second weather monitoring device may communicate the determined weather conditions to the aircraft 102.

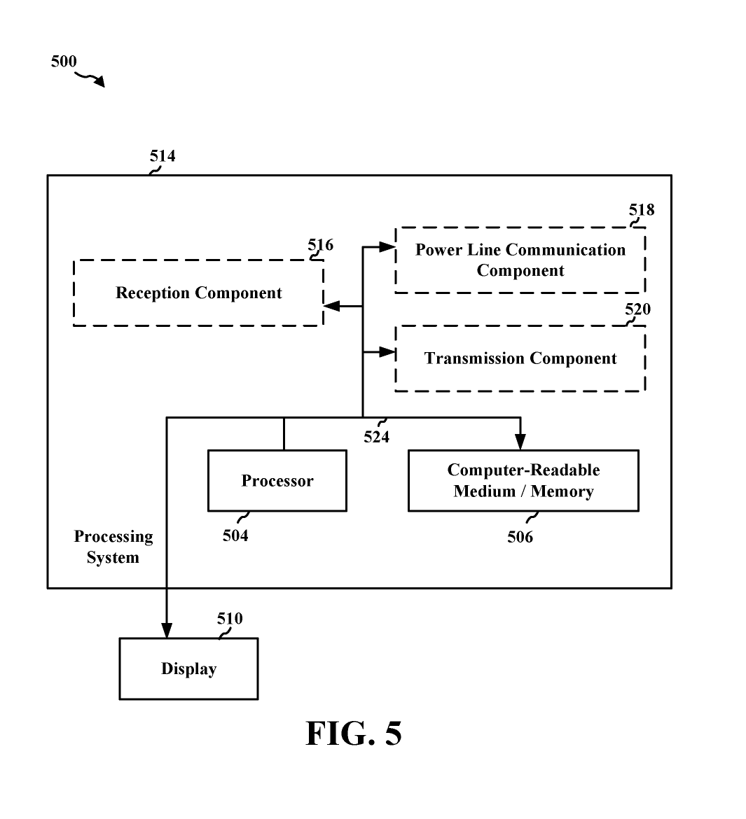

FIG. 5 is a diagram illustrating an example hardware implementation for a system 500 employing a processing system 514. The processing system 514 may be implemented with an architecture that links together various circuits, including, for example, one or more processors and/or components, represented by the processor 504, the components 516, 518, 520 and the computer-readable medium/memory 506.

The processing system 514 may be coupled to the second ground station 110, e.g., such as one or more of an RCSU, a DME ground system, a localizer, a glide slope, a TACAN system, a VOR system, an ILS, MB, NDB, on-airfield equipment, an airfield site intercom device, an airfield site maintenance monitoring device, ATIS equipment, runway visual range equipment, or airport weather monitoring equipment, just to name a few. The processing system 514 may use power line communication to communicate with the first ground station 104, e.g., such as an RCSU, an airfield site intercom device, maintenance monitoring equipment, an airfield site maintenance monitoring device, a DME ground system, ATIS equipment, runway visual range equipment, and/or airport monitoring equipment, just to name a few. The processing system 514 may wirelessly communicate with the aircraft 102.

The processing system 514 may include a processor 504 coupled to a computer-readable medium/memory 506 and display 510 via bus 524. The processor 504 may be responsible for general processing, including the execution of software stored on the computer-readable medium/memory 506. The software, when executed by the processor 504, may cause the processing system 514 to perform various functions described supra for any particular apparatus and/or system. The computer-readable medium/memory 506 may also be used for storing data that is manipulated by the processor 504 when executing software. The processing system may further include at least one of the components 516, 518, 520. The components may comprise software components running in the processor 504, resident/stored in the computer readable medium/memory 506, one or more hardware components coupled to the processor 504, or some combination thereof. The processing system 514 may comprise a component of the second ground station 110, e.g., as described above in connection with FIG. 1

The system 500 may further include features for providing power line communication among the plurality of ground-based aeronautical equipment installations, the plurality of ground-based aeronautical equipment installations including a first station and a second station; receiving, using the power line communication, a signal at the first station from the second station; wherein the first station includes a localizer, the second station includes a DME station, and the signal includes an identification synchronization signal; wherein the first station includes a ground-based navigational aid station, the second station includes a monitoring device, and the signal includes information associated with a status of the ground-based navigational aid station; wherein the ground-based navigational aid station includes at least one of a DME ground system, a localizer, a glide slope, a TACAN system, a VOR system, an ILS, an MB, an NDB, or a maintenance monitoring device; wherein the monitoring device includes a RCSU or a maintenance monitoring unit; wherein the first station includes a first intercom device at a first airfield site, the second station includes a second intercom device at a second airfield site, and the signal includes information to be output at the second intercom device; wherein the first station includes a first ATIS device, the second station includes a second ATIS device, and the signal includes information associated with aeronautical information to be output at the second ATIS device; wherein the first station includes a first RVR device, the second station includes a second RVR device, and the signal includes information associated with RVR; wherein the first station includes a first airport weather monitoring device, the second station includes a second airport weather monitoring device, and the signal includes information associated with meteorology; communicating information associated with the signal; wherein the information may include one or more of RVR information, meteorology information, or ATIS information that is wirelessly communicated to an aircraft; wherein the information may include status information associated with one or more of a DME ground system, a localizer, a glide slope, a TACAN system, a VOR system, an ILS, an MB, an NDB, or a maintenance monitoring device that is output at a display at a RCSU; and wherein the first station includes a VOR, the second station includes a cellular base station, and the signal includes maintenance information intended for a maintenance center.

The aforementioned features may be carried out via one or more of the aforementioned components of the system 500 and/or the processing system 514 of the system 500 configured to perform the functions recited by the aforementioned features.

Thus, aspects may include a system for enabling communication between a remote device and one or more ground devices using power line communication, e.g., in connection with FIG. 5.

The system may include additional components that perform each of the functions of the method of the aforementioned flowchart of FIG. 4, or other algorithm. As such, each block in the aforementioned flowchart of FIG. 4 may be performed by a component, and the system may include one or more of those components. The components may include one or more hardware components specifically configured to carry out the stated processes/algorithm, implemented by a processor configured to perform the stated processes/algorithm, stored within a computer-readable medium for implementation by a processor, or some combination thereof.

Thus, aspects may include a non-transitory computer-readable medium for performing a hazard analysis of navigation aid equipment using a safety monitor, the non-transitory computer-readable medium having control logic stored therein for causing a computer to perform the aspects described in connection with, e.g., FIG. 4.

FIG. 6 is an example system diagram of various hardware components and other features, for use in accordance with aspects presented herein. The aspects may be implemented using hardware, software, or a combination thereof and may be implemented in one or more computer systems or other processing systems. In one example, the aspects may include one or more computer systems capable of carrying out the functionality described herein, e.g., in connection with FIGS. 2 and/or 4. An example of such a computer system 300, 500 is shown in FIGS. 3 and 5, respectively.

In FIG. 6, computer system 600 includes one or more processors, such as processor 604. The processor 604 is connected to a communication infrastructure 606 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

In alternative aspects, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 614, a hard disk installed in hard disk drive 612, and signals 628. These computer program products provide software to the computer system 600. Aspects presented herein may include such computer program products.

Computer programs (also referred to as computer control logic) are stored in main memory 608 and/or secondary memory 610. Computer programs may also be received via communications interface 624. Such computer programs, when executed, enable the computer system 600 to perform the features presented herein, as discussed herein. In particular, the computer programs, when executed, enable the processor 604 to perform the features presented herein. Accordingly, such computer programs represent controllers of the computer system 600.

In aspects implemented using software, the software may be stored in a computer program product and loaded into computer system 600 using removable storage drive 614, hard disk drive 612, or communications interface 624. The control logic (software), when executed by the processor 604, causes the processor 604 to perform the functions as described herein. In another example, aspects may be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A method of assuring reliable communication, providing power and communication to the plurality of ground-based aeronautical equipment installations, the method comprising:
providing power line communication among the plurality of ground-based aeronautical equipment installations, the plurality of ground-based aeronautical equipment installations including a first station and a second station;
receiving through the power line communication signals transmitted by the first and second stations; and
communicating information associated with the signals.

2. The method of claim 1, wherein the providing of power line communications among the plurality of ground-based aeronautical equipment installations comprises superimposing low-energy information signals generated by individual ones of the ground-based aeronautical equipment installations onto power waveforms provided through power lines to the ground-based aeronautical equipment installations to power operational circuits therein.

3. The method of claim 2, wherein the low-energy information signals superimposed on the power waveforms are transmitted from any one of the ground-based aeronautical equipment installations through respective ones of the power lines to all of the other ground-based aeronautical equipment installations.

4. The method of claim 1, wherein the first station includes a localizer, the second station includes a distance measurement equipment (DME) station, and one of the signals includes an identification synchronization signal that is superimposed as a low-energy information signal onto power waveforms provided through a power line connected the DME station.

5. The method of claim 1, wherein the first station includes a ground-based navigational aid station, the second station includes a monitoring device, and one of the signals includes information associated with a status of the ground-based navigational aid station that is generated by the ground-based navigational aid station and communicated superimposed as a low-energy information signal onto power waveforms through a power line connected to the ground-based navigational aid station.

6. The method of claim 5, wherein:
the ground-based navigational aid station includes at least one selected from a group consisting of a distance measurement equipment (DME) ground system, a localizer, a glide slope, a TACtical Air Navigation (TACAN) system, a Very high frequency Omni-directional Range (VOR) system, an Instrument Landing System (ILS), Marker Beacons (MB), Non-Directional Beacons (NDB), and a maintenance monitoring device, and the monitoring device includes a remote status and control unit (RCSU) or a maintenance monitoring unit.

7. The method of claim 1, wherein the first station includes a first intercom device at a first airfield site, the second station includes a second intercom device at a second airfield site, and one of the signals includes information generated by the first intercom device that is superimposed as a low-energy information signal onto power waveforms through the power line connected to the first intercom device and communicated superimposed as a low-energy information signal onto power waveforms through the power line connected to the second intercom device.

8. The method of claim 1, wherein the first station includes a first Automatic Terminal Information Service (ATIS) device, the second station includes a second ATIS device, and one of the signals includes information associated with aeronautical information generated by the first Automatic Terminal Information Service device that is superimposed as a low-energy information signal onto power waveforms through the power line connected to the first Automatic Terminal Information Service device and communicated superimposed as a low-energy information signal onto power waveforms through the power line connected to the second ATIS device.

9. The method of claim 1, wherein the first station includes a first runway visual range (RVR) device, the second station includes a second RVR device, and one of the signals includes information associated with a status of first RVR device that is generated by the first RVR device and communicated superimposed as a low-energy information signal onto power waveforms through the power line connected to the first RVR device, and another one of the signals includes information associated with a status of second RVR device that is generated by the second RVR device and communicated superimposed as a low-energy information signal onto power waveforms through the power line connected to the second RVR device.

10. The method of claim 1, wherein the first station includes a first airport weather monitoring device, the second station includes a second airport weather monitoring device, and one of the signals includes information associated with a status of first airport weather monitoring device that is generated by the first airport weather monitoring device and communicated superimposed as a low-energy information signal onto power waveforms through the power line connected to the first airport weather monitoring device, and another one of the signals includes information associated with a status of second airport weather monitoring device that is generated by the second airport weather monitoring device and communicated superimposed as a low-energy information signal onto power waveforms through the power line connected to the second airport weather monitoring device.

11. The method of claim 1, wherein the first station includes a Very high frequency Omni-directional Range (VOR), the second station includes a cellular base station, and one of the signals includes maintenance information intended for a maintenance center.

12. The method of claim 1, wherein the information includes one or more of runway visual range (RVR) information, meteorology information, or Automatic Terminal Information Service (ATIS) information that is wirelessly communicated to an aircraft.

13. The method of claim 1, wherein the information includes status information associated with one or more of a distance measurement equipment (DME) ground system, a localizer, a glide slope, a TACtical Air Navigation (TACAN) system, a Very high frequency Omni-directional Range (VOR) system, an Instrument Landing System (ILS), Marker Beacons (MB), Non-Directional Beacons (NDB), or a maintenance monitoring device that is output at a display at a remote status and control unit (RCSU).

14. An apparatus for assuring reliable communication among plurality of ground-based aeronautical equipment installations, the apparatus comprising:
a memory; and
at least one processor coupled to the memory and configured to:
provide power line communication among the plurality of ground-based aeronautical equipment installations, the plurality of ground-based aeronautical equipment installations including a first station and a second station;
receive, using the power line communication, signals at the second station transmitted from the first station; and
communicate information associated with the signals.

15. The apparatus of claim 14, wherein the providing of power line communications among the plurality of ground-based aeronautical equipment installations comprises superimposing low-energy information signals generated by individual ones of the ground-based aeronautical equipment installations onto power waveforms provided through power lines to the ground-based aeronautical equipment installations to power operational circuits therein.

16. The apparatus of claim 15, wherein the low-energy information signals superimposed on the power waveforms are transmitted from any one of the ground-based aeronautical equipment installations through respective ones of the power lines to all of the other ground-based aeronautical equipment installations.

17. The apparatus of claim 14, wherein the first station includes a localizer, the second station includes a distance measurement equipment (DME) station, and one of the signals includes an identification synchronization signal that is superimposed as a low-energy information signal onto power waveforms provided through a power line connected the DME station.

18. The apparatus of claim 17, wherein the first station includes a ground-based navigational aid station, the second station includes a monitoring device, and one of the signals includes information associated with a status of the ground-based navigational aid station that is generated by the ground-based navigational aid station and communicated superimposed as a low-energy information signal onto power waveforms through a power line connected to the ground-based navigational aid station.

19. The apparatus of claim 14, wherein:
the ground-based navigational aid station includes at least one selected from a group consisting of a distance measurement equipment (DME) ground system, a localizer, a glide slope, a TACtical Air Navigation (TACAN) system, a Very high frequency Omni-directional Range (VOR) system, an Instrument Landing System (ILS), Marker Beacons (MB), Non-Directional Beacons (NDB), and a maintenance monitoring device, and
the monitoring device includes a remote status and control unit (RCSU) or a maintenance monitoring unit.

20. The apparatus of claim 14, wherein the first station includes a first intercom device at a first airfield site, the second station includes a second intercom device at a second airfield site, and one of the signals includes information generated by the first intercom device that is superimposed as a low-energy information signal onto power waveforms through the power line connected to the first intercom device and communicated superimposed as a low-energy information signal onto power waveforms through the power line connected to the second intercom device.

21. The apparatus of claim 14, wherein the first station includes a first Automatic Terminal Information Service (ATIS) device, the second station includes a second ATIS device, and one of the signals includes information associated with aeronautical information generated by the first Automatic Terminal Information Service device that is superimposed as a low-energy information signal onto power waveforms through the power line connected to the first Automatic Terminal Information Service device and communicated superimposed as a low-energy information signal onto power waveforms through the power line connected to the second ATIS device.

22. The apparatus of claim 14, wherein the first station includes a first runway visual range (RVR) device, the second station includes a second RVR device, and one of the signals includes information associated with a status of first RVR device that is generated by the first RVR device and communicated superimposed as a low-energy information signal onto power waveforms through the power line connected to the first RVR device, and another one of the signals includes information associated with a status of second RVR device that is generated by the second RVR device and communicated superimposed as a low-energy information signal onto power waveforms through the power line connected to the second RVR device.

23. The apparatus of claim 14, wherein the first station includes a first airport weather monitoring device, the second station includes a second airport weather monitoring device, and one of the signals includes information associated with a status of first airport weather monitoring device that is generated by the first airport weather monitoring device and communicated superimposed as a low-energy information signal onto power waveforms through the power line connected to the first airport weather monitoring device, and another one of the signals includes information associated with a status of second airport weather monitoring device that is generated by the second airport weather monitoring device and communicated superimposed as a low-energy information signal onto power waveforms through the power line connected to the second airport weather monitoring device.

24. The apparatus of claim 14, wherein the first station includes a Very high frequency Omni-directional Range (VOR), the second station includes a cellular base station, and one of the signals includes maintenance information intended for a maintenance center.

25. The apparatus of claim 14, wherein the information includes one or more of runway visual range (RVR) information, meteorology information, or Automatic Terminal Information Service (ATIS) information that is wirelessly communicated to an aircraft.

26. The apparatus of claim 14, wherein the information includes status information associated with one or more of a distance measurement equipment (DME) ground system, a localizer, a glide slope, a TACtical Air Navigation (TACAN) system, a Very high frequency Omni-directional Range (VOR) system, an Instrument Landing System (ILS), Marker Beacons (MB), Non-Directional Beacons (NDB), or a maintenance monitoring device that is output at a display at a remote status and control unit (RCSU).

27. A computer-readable medium storing computer executable code to assure reliable communication among plurality of ground-based aeronautical equipment installations, comprising code to:
provide power line communication among the plurality of ground-based aeronautical equipment installations, the plurality of ground-based aeronautical equipment installations including a first station and a second station;
receive, using the power line communication, signals at the second station transmitted from the first station; and
communicate information associated with the signals.
